(19) United States
(12) Patent Application Publication
(10) Pub. No.: US 2016/0313879 A1
(43) Pub. Date: Oct. 27, 2016

(54) DISPLAY DEVICE AND METHOD FOR CONTROLLING SAME

(71) Applicant: SAMSUNG ELECTRONICS CO., LTD., Suwon-si (KR)

(72) Inventors: Min-jin KIM, Pyeongtaek-si (KR); Jong-bo MOON, Suwon-si (KR); Do-sung JUNG, Seoul (KR); Sung-Hee CHO, Seoul (KR); Yun-hee CHOI, Seongnam-si (KR); Je-sun HWANG, Bucheon-si (KR)

(73) Assignee: SAMSUNG ELECTRONICS CO., LTD., Suwon-si (KR)

(21) Appl. No.: 15/199,308

(22) Filed: Jun. 30, 2016

Related U.S. Application Data
(63) Continuation of application No. PCT/KR2014/012946, filed on Dec. 29, 2014.

(30) Foreign Application Priority Data
Jan. 3, 2014 (KR) 10-2014-0000545

(51) Int. Cl. G06F 3/0482; G06F 3/0346; G06F 3/0481

(52) U.S. Cl. CPC G06F 3/0482; G06F 3/04817; G06F 3/0346

(57) ABSTRACT

A display device and a method for controlling the same for intuitively informing a user of motion of an input device when a cursor is not displayed by providing visual feedback in a region of a display item corresponding to the motion of the input device.

### CROSS-REFERENCE TO RELATED APPLICATIONS

This application is a continuation application of International Application No. PCT/KR2014/012946, filed Dec. 29, 2014, which claims priority from Korean Patent Application No. 10-2014-0000545, filed on Jan. 3, 2014, in the Korean Intellectual Property Office, the disclosures of which are incorporated herein by reference in their entireties.

### BACKGROUND

1. Field

Apparatuses and methods consistent with exemplary embodiments of the present application relate to a display device and a method for controlling the same, and more particularly, to a display device and a method for providing a feedback user interface (UI) to a region of a display item corresponding to motion direction of an input device.

2. Description of the Related Art

A display device may use a plurality of display items and a highlight to perform various functions. In particular, to perform various functions using the plurality of display items and the highlight, the existing display device may implement a four-way button or a pointer to manipulate the highlight, and selection of a highlighted item may be implemented by an enter button or the like.

In detail, when manipulating the highlight using the four-way button, the display device uses the four-way button to move the highlight and uses the enter button to select the display item on which the highlight is positioned. However, when the display device uses the four-way button to manipulate the highlight, movement of the highlight using the four-way button is less intuitive to a user than manipulating the highlight using the pointer, as it may be inconvenient to repeatedly manipulate the four-way button to control the highlight.

To position the highlight on the display item using the pointer, however, high precision manipulation is required. Therefore, it may also be inconvenient for the user to select an item on the display. In particular, when the user uses the pointer to move the highlight, the highlight may be moved in a direction that is unintended by the user.

Therefore, a method for precisely manipulating a display item using a pointer is required.

### SUMMARY

Exemplary embodiments overcome the above disadvantages and other disadvantages not described above. Also, the exemplary embodiments are not required to overcome the disadvantages described above, and an exemplary embodiment may not overcome any of the problems described above.

Methods and apparatuses consistent with exemplary embodiments provide a display device and a method for providing a feedback user interface (UI) to a region of a display item corresponding to motion direction of an input device.

According to an aspect of an exemplary embodiment, there is provided a method for controlling a display device including displaying a plurality of display items on a display screen of the display device; obtaining coordinates of a position on the display screen of the display device indicated by an input device; highlighting a first display item among the plurality of display items that is displayed at the coordinates; determining a motion direction of the input device based on motion information received from the input device; and displaying a feedback user interface (UI) in a region of the first display item corresponding to the determined motion direction of the input device.

The displaying may include displaying the feedback UI on a face of the first display item corresponding to the motion direction of the input device, the determined motion direction of the input device corresponding to one of up, down, left, and right directions.

The displaying may include displaying the feedback UI on two faces of the first display item corresponding to the motion direction of the input device, the determined motion direction of the input device corresponding to a diagonal direction.

The displaying may include displaying the feedback UI around all faces of the first display item, the determined motion direction of the input device corresponding to a rotational direction within coordinates of the first display item.

A size of the feedback UI may increase proportionally to a size of a motion value of the input device.

The method may further include: determining that the position indicated by the input device is moved beyond a preset value from coordinates of the first display item, removing the feedback UI and the highlighting from the first display item and highlighting a second display item among the plurality of display items positioned adjacent to the first display item in a direction of the motion direction of the input device.

The determining may include calculating a direction vector based on the obtained coordinates and the subsequent coordinates indicated by the input device and determining the motion direction of the input device is based on the direction vector.

The input device may be a remote controller of the display device, the remote controller comprising a motion sensor configured to sense motion of the remote controller.

According to an aspect of an exemplary embodiment, there is provided a display device including a display configured to display a plurality of display items; a communication interface configured to receive from an input device signaling indicating coordinates of a position on the display of the display device indicated by the input device; and a controller configured to obtain the coordinates based on the information in the signaling, control the display to highlight a first display item among the plurality of display items that is displayed at the coordinates, determine a motion direction of the input device based on motion information in the signaling received by the communication interface from the input device, and display a feedback user interface (UI) in a region of the first display item corresponding to the determined motion direction of the input device.

The controller may be further configured to control the display to display the feedback UI on a face of the first display item corresponding to the motion direction of the input device, the determined motion direction of the input device corresponding to one of up, down, left, and right directions.

The controller may be further configured to control the display to display the feedback UI on two faces of the first display item corresponding to the motion direction of the input device, the determined motion direction of the input device corresponding to a diagonal direction.

The controller may be further configured to control the display to display the feedback UI around all faces of the first display item, the determined motion direction of the input device corresponding to a rotational direction within coordinates of the first display item.

The controller may be further configured to control the display to increase a size of the feedback UI in proportion to a size of a motion value of the input device.

According to an aspect of an exemplary embodiment, there is provided a display device including a display configured to display a user interface, the user interface comprising a first icon having a polygon shape, a communication interface configured to receive, from a remote controller of the display device, position information that indicates a position of the of the display pointed to by the remote controller, the position information comprising first position information that indicates a first position of the display device pointed to by the remote controller and second position information that indicates a second position of the display device pointed to by the remote controller, and a processor configured to determine a direction of motion of the remote controller from the first position to the second position based on a difference between the first position information and the second position information and control the display to display an indication of the direction of the motion extending from the first icon based on the direction of the motion of the remote controller.

As set forth above, according to various aspects of the exemplary embodiments, the user may intuitively determine the motion of the input device to more accurately perform user interface manipulation.

### BRIEF DESCRIPTION OF THE DRAWINGS

The above and other aspects will be more apparent by describing certain exemplary embodiments with reference to the accompanying drawings, in which:

FIG. 1 is a block diagram illustrating a configuration of a display device according to an exemplary embodiment;

FIG. 2 is a block diagram illustrating a configuration of a display device according to an exemplary embodiment;

FIGS. 3A to 3C are diagrams illustrating a method of moving a highlight depending on motion of an input device according to an exemplary embodiment;

FIGS. 4A to 4C are diagrams illustrating a method for providing a feedback user interface based on motion of an input device according to an exemplary embodiment;

FIGS. 5A to 5C are diagrams illustrating a method of providing a feedback user interface based on diagonal motion of an input device according to an exemplary embodiment;

FIGS. 6A and 6B are diagrams illustrating a method for providing a feedback user interface based on rotational motion of an input device according to an exemplary embodiment;

FIGS. 7A to 7C are diagrams for describing a method for providing a page changing UI according to an exemplary embodiment; and

FIG. 8 is a flow chart illustrating a method of controlling a display device according to an exemplary embodiment.

### DETAILED DESCRIPTION OF THE EXEMPLARY EMBODIMENTS

Hereinafter, exemplary embodiments will be described in more detail with reference to the accompanying drawings.

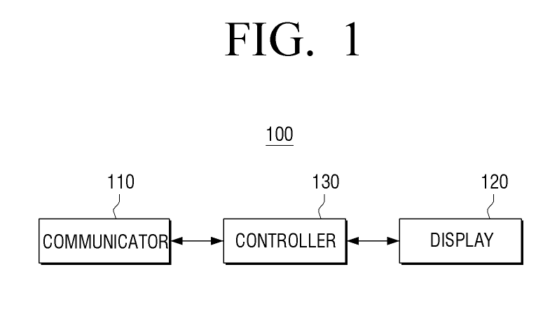

FIG. 1 is a block diagram illustrating a configuration of a display device according to an exemplary embodiment.

As illustrated in FIG. 1, the display device 100 includes a communicator 110, a display 120, and a controller 130. The display device 100 may be a display device such as a smart television (TV), which is only an example, or other display device such as a desktop personal computer (PC), a tablet PC, and a smart phone.

The communicator 110 communicates with external input devices. The communicator 110 may receive signals from an input device indicating at least one of motion information of the input device and a button selection on the input device. Further, the communicator 110 may receive signals from the input device indicating information on coordinates of a position currently indicated by the input device.

The input device may be implemented as a remote controller, which may control the display device 100. The input device may include a motion sensor (e.g., gyroscope) that may sense a motion, but is not limited thereto. The input device may be implemented as other input devices including a motion sensor.

The display 120 displays image data based on control signals of the controller 130. In particular, the display 120 may display a plurality of display items and may display a highlight on one of the plurality of display items. The highlight may correspond to a position indicated by the input device.

The controller 130 controls the general functions of the display device 100. In detail, the controller 130 may obtain the coordinates of the position indicated by the input device based on the information in the signals received through the communicator 110. The controller 130 may control the display 120 to display the highlight on a first display item positioned at the determined position (e.g., coordinates of the display 120). Further, when the position indicated by the input device is altered, the controller 130 may determine the motion direction of the input device based on the obtained coordinates. Accordingly, the controller 130 may control the display 120 to display a feedback user interface (UI) in the region of a currently selected display item, and the feedback UI may correspond to motion direction of the input device. In this case, the feedback UI may be implemented as visual feedback on the display item. For example, the visual feedback may adjust a shape of the display item as being morphed into a different shape. For example, as discussed in detail below, one or more sides of a the display item in the shape of a square may be extended in an arch shape or quadrangle shape. The shape of the adjustment to the display item may correspond to the motion direction of the input device.

In detail, the controller 130 may calculate a direction vector (i.e., direction and magnitude) based on an initial position (i.e., the initial coordinates indicated by the input device) and the subsequent coordinates (i.e., the adjusted coordinates indicated by the adjusted input device). The controller 130 may detect the motion direction and a motion magnitude based on the difference between the initial coordinates and the subsequent coordinates. That is, the controller 130 may calculate the direction vector based on the initial coordinates as a starting point and the subsequent coordinates as an ending point.

Further, when the motion direction of the input device corresponds to one of up, down, left, and right directions, the controller 130 may control the display 120 to display the feedback UI on the face of the display item corresponding to the motion direction of the input device among the faces of the first display item. For example, when the motion direction of the input device is a right direction, the controller 130 may control the display 120 to display the feedback UI on a right face of a display item having a square shape.

Further, when the determined motion direction of the input device is a diagonal direction, the controller 130 may control the display 120 to display the feedback UI on two faces corresponding to the motion direction of the input device among four faces of the display item having a square shape. For example, when the motion direction of the input device is an upper-right diagonal direction, the controller 130 may control the display 120 to display the feedback UI on the right face and an upper face of the display item having a square shape.

Further, when the input device is rotated while the position indicated by the input device is maintained in the display item, the controller 130 may control the display 120 to display the feedback UI on the four faces of the first display item.

In particular, the controller 130 may control the display 120 to increase a size of the feedback UI as a motion value of the input device is increased. That is, the controller 130 may directly correlate the size of the calculated direction vector to the magnitude of motion of the input device, thereby correspondingly increasing the size of the feedback UI.

Further, when the position indicated by the input device is moved sufficiently away from a first display item by a preset value, the controller 130 may remove the feedback UI and control the display 120 to move the highlight to a next display item positioned in the motion direction of the input device relative to the first display item. For example, when the input device is moved in the upper-right direction and then the position indicated by the input device is sufficiently distant from the first display item by at least the preset value, the controller 130 may remove the feedback UI and control the display 120 to move the highlight from the first display item to the next display item positioned in the upper-right direction.

When a position indicated by an input device is within a preset distance of four edges of a display screen, the controller 130 may control the display 120 to display a page changing UI on the edge of the display screen. Further, when the position indicated by the input device contacts one of the edges of the display screen, the controller 130 may change a page to a corresponding direction of the face that the point indicated by the input device contacts. For example, when the position contacts a left edge of the display screen, a previous page of content may be displayed. On the other hand, when the contacts a right edge of the display screen, a next page of content may be displayed.

By using the display device as described above, the user may more intuitively control the display device through the feedback UI and the page changing UI.

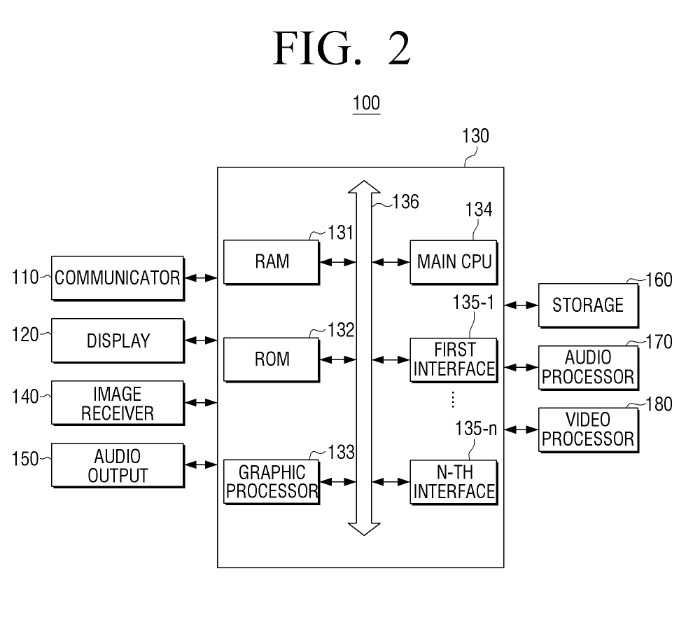

Hereinafter, the display device will be described in more detail with reference to FIGS. 2 to 7C.

FIG. 2 is a block diagram illustrating a configuration of a display device according to an exemplary embodiment.

As illustrated in FIG. 2, the display device 100 includes the communicator 110, the display 120, the controller 130, an image receiver 140 (i.e., input interface), an audio output 150 (i.e., audio output interface), a storage 160 (i.e., memory), an audio processor 170, and a video processor 180.

The communicator 110 is a communication interface configured to communicate with various types of external devices according to various types of communication protocols. The communicator 110 may include various communication chips such as a Wi-Fi chip, a Bluetooth chip, a near field communication (NFC) chip, a wireless communication chip, an IR chip, and the like. Here, the Wi-Fi chip, the Bluetooth chip, the NFC chip, and the IR chip each perform communication in a Wi-Fi scheme, a Bluetooth scheme, an NFC scheme, and an IR standard. For example, the NFC chip operates in a near field communication (NFC) protocol using a band of 13.56 MHz among various RF-ID frequency bands such as 135 kHz, 13.56 MHz, 433 MHz, 860 to 960 MHz, and 2.45 GHz. In the case of using the Wi-Fi chip or the Bluetooth chip, various types of connection information such as an SSID and a session key are first transmitted and received to perform communication connection, and then various types of information may be transmitted and received. The wireless communication chip may implement various communication protocols such as IEEE 802.11x, Zigbee, 3rd generation (3G), 3rd generation partnership project (3GPP), long term evolution (LTE), and the like.

The communicator 110 may communicate with the external input devices to receive the motion information (or coordinates information) and the button select command from the input device. Meanwhile, the input device may be the remote controller including the motion sensor that may sense the user motion. Therefore, the input device may be implemented as other input devices (for example, pointing device) including a motion sensor.

The display 120 displays image data received by the image receiver 140, a video frame processed by the video processor 180, and at least one of various screens generated from the graphic processor 133. In particular, the display 120 may display a plurality of display items (e.g., icons) and may display a highlight on one of the plurality of display items.

The image receiver 140 receives image data from one or more sources. For example, the image receiver 140 may receive broadcasting data from an external broadcasting station and receive the image data from external devices (for example, DVD device).

The audio output 150 is a component for outputting various alarm sounds or voice messages in addition to various audio data processed by the audio processor 170.

The storage 160 stores various modules for driving the display device 100. For example, the storage 160 may store softwares including a base module, a sensing module, a communication module, a presentation module, a web browser module, and a service module. In this case, the base module is a basic module that processes signals transferred from each hardware component included in the display device 100 and transfers the processed signals to an upper layer module. The sensing module is a module collecting information from various sensors and analyzing and managing the collected information and may include a face recognition module, an audio recognition module (e.g., speech recognition module), a motion recognition module, an NFC recognition module, and the like. The presentation module is a module for configuring a display screen and may include a multimedia module for reproducing and outputting multimedia contents and an UI rendering module for performing UI and graphic processing. The communication module is a module for communicating with other devices. The web browser module is a module for performing web browsing to access a web server. The service module is a module including various applications for providing various services.

As described above, the storage 160 may include various program modules some of which may be omitted, changed, or added according to a kind and characteristics of the display device 100. For example, when the display device 100 is implemented as a tablet PC, the base module may further include a position determination module for determining a GPS based location and the sensing module may further include the sensing module for sensing an operation of a user.

Further, the storage 160 may store various modules for manipulating the highlight depending on the motion direction of the input device and providing the feedback UI.

The audio processor 170 is a component for performing processing on audio data. The audio processor 170 may perform various processings, such as decoding, amplification, and noise filtering, on the audio data. The audio data processed by the audio processor 170 may be output to the audio output 150, which may include an audio output interface and one or more speakers.

The video processor 180 is a component for processing image data received by the image receiver 140. The video processor 180 may perform various image processings, such as decoding, scaling, noise filtering, frame rate conversion, and resolution conversion, on the video data.

The controller 130 controls the general operations of the display device 100 by executing various programs stored in the storage 160.

As illustrated in FIG. 2, the controller 130 includes an RAM 131, an ROM 132, a graphic processor 133, a main CPU 134, first to n-th interfaces 135-1 to 135-n, and a bus 136. In this case, the RAM 131, the ROM 132, the graphic processor 133, the main CPU 134, the first to n-th interfaces 135-1 to 135-n, and the like may be connected to each other via the bus 136.

A set of commands for system booting, and the like is stored in the ROM 132. When a power on command is input and thus power is supplied, the main CPU 134 copies an O/S stored in the storage 160 to the RAM 131 according to the command stored in the ROM 132 and executes the O/S to boot the system. When the booting is completed, the main CPU 134 copies various application programs stored in the storage 160 to the RAM 131 and executes the application programs copied to the RAM 131 to perform various operations.

The graphic processor 133 uses an operator and a renderer to create a screen including various objects such as a pointer, an icon, an image, and a text. The operator uses the control command received from the input to operate attribute values, such as coordinates, forms, sizes, and colors in which each object will be displayed according to a layout of the screen. The renderer generates a screen of various layouts including objects based on the attribute values that are operated by the operator. The screen generated by the renderer is displayed in a display region of the display 120.

The main CPU 134 accesses the storage 160 to perform booting using the O/S stored in the storage 160. Further, the main CPU 134 performs various operations executing and processing various programs, contents, data, and the like that are stored in the storage 160.

The first to n-th interfaces 135-1 to 135-n are connected to the foregoing various components. One of the interfaces may be a network interface (e.g., wireless WiFi interface, wired Ethernet interface), which is connected to the external devices directly or through a network.

In particular, the controller 130 obtains the coordinates of the position indicated by the input device based on the information received through the communicator 110. In particular, when the motion information of the input device is received from the input device, the controller 130 may calculate the coordinates based on the motion information received from the input device. Further, the controller 130 may receive information on the coordinates of the position indicated by the input device from the input device.

Further, the controller 130 may control the display 120 to display the highlight on the first display item positioned at the coordinates. In this case, the controller 130 may not display the pointer at the coordinates of the point indicated by the input device. However, this is only an example and the pointer may be displayed at the position indicated by the input device. In this case, the pointer may be displayed translucently to avoid overly obscuring any underlying item displayed on the display.

When the position indicated by the input device is adjusted, the controller 130 may use coordinates of an initial position and coordinates of a subsequent position to determine the motion direction of the input device. In detail, the controller 130 may set the initially obtained coordinates of the position as a starting point and the subsequently obtained coordinates as an ending point to calculate the direction vector between the starting point and the ending point.

Further, the controller 130 may determine the direction of the direction vector to determine the motion direction of the input device. In this case, the controller 130 may determine the motion direction of the input device as one of the up, down, left, and right directions and the four diagonal directions (upper-right direction, upper-left direction, lower-right direction, lower-left direction). The controller 130 may move the highlight in a direction corresponding to the determined motion direction of the input device.

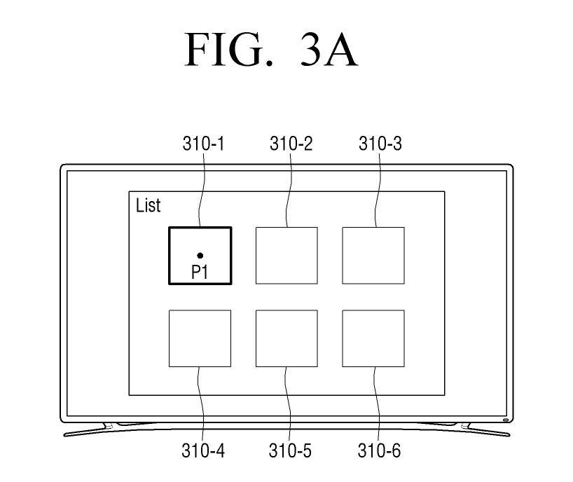

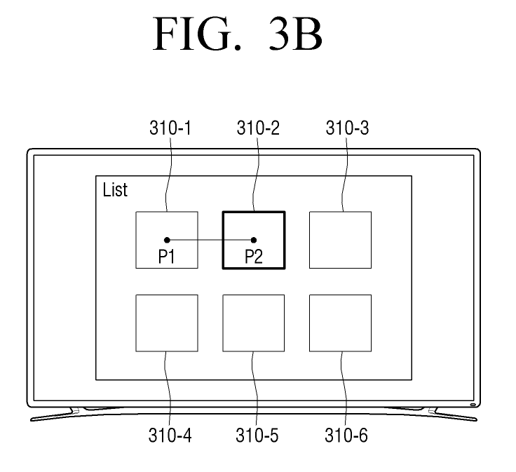

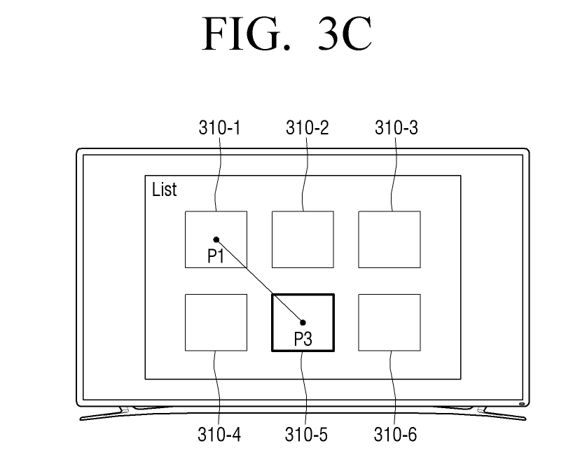

FIGS. 3A to 3C are diagrams illustrating a method of moving a highlight depending on motion of an input device according to an exemplary embodiment.

For example, as illustrated in FIG. 3A, when the input device is positioned at point P1 while the quadrangular first display item to sixth display item 310-1 to 310-6 are displayed, the controller 130 may control the display 120 to distinguishably display the first display item 310-1. For example, the display item 310-1 may be highlighted. Further, as illustrated in FIG. 3B, when the position indicated by the input device is moved to position P2, the controller 130 may calculate the direction vector using coordinates P1 and P2 and determine the rightward direction, which is the direction of the direction vector, as the motion direction of the input device. Further, as illustrated in FIG. 3B, the controller 130 may control the display 120 to move the highlight to the second display item 310-2 positioned to the right of the first display item 310-1.

When the motion direction of the input device is determined as a diagonal, the controller 130 may move the highlight to the display item positioned at the diagonal direction.

For example, as illustrated in FIG. 3C, when the point indicated by the input device is moved to position P3, the controller 130 may calculate the direction vector using coordinates P1 and P3 and determine the lower-right direction, which is the direction of the direction vector, as the motion direction of the input device. As illustrated in FIG. 3C, the controller 130 may control the display 120 to move the highlight to the fifth display item 310-5 positioned at the lower-right of the first display item 310-1.

The foregoing exemplary describes that the highlight is directly moved depending on the motion direction of the input device, which is only an example. Therefore, the feedback UI may be displayed in the display item depending on the motion direction of the input device to guide the motion direction of the input device to the user.

In detail, the controller 130 may control the display 120 to display the feedback UI in the region of the first display item corresponding to the determined motion direction of the input device. In this case, when the position indicated by the input device is present within a preset distance from a face of the first display item, the controller 130 may control the display 120 to display the feedback UI. That is, when the point indicated by the input device is positioned in a central region of the first display item, the controller 130 may control the display 120 not to display the feedback UI, but when the position indicated by the input device is positioned near each face of the first display item, the controller 130 may control the display 120 to display the feedback UI.

In particular, when the determined motion direction of the input device corresponds to one of up, down, left, and right directions, the controller 130 may control the display 120 to display the feedback UI on the face of the display item corresponding to the motion direction of the input device.

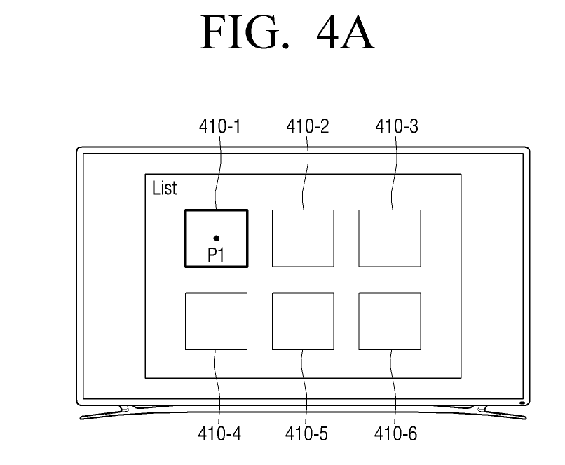

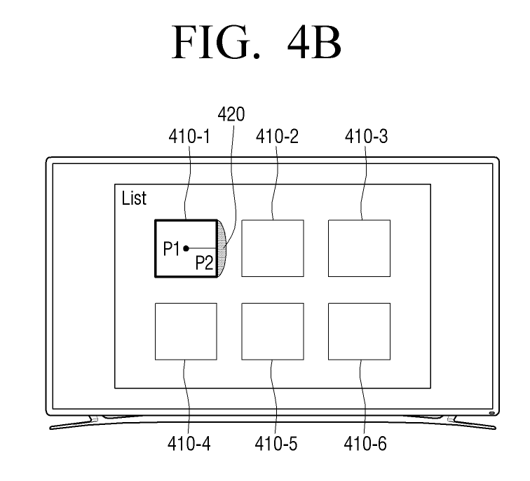

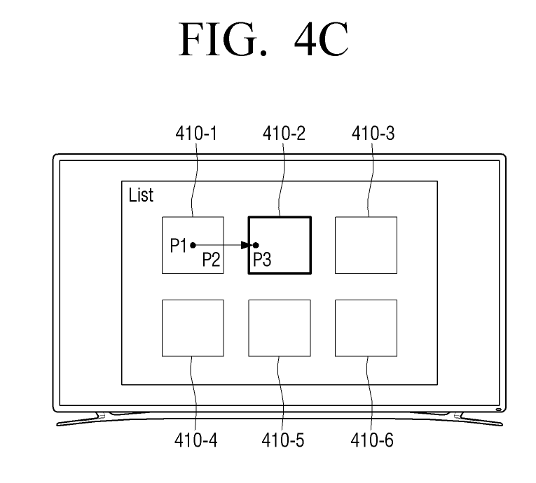

FIGS. 4A to 4C are diagrams illustrating a method for providing a feedback user interface based on motion of an input device according to an exemplary embodiment.

For example, as illustrated in FIG. 4A, when the input device indicates the position P1 while first display item to sixth display item 410-1 to 410-6 are displayed, the controller 130 may control the display 120 to highlight the first display item 410-1. Further, when the input device is moved to the position P2, the controller 130 may calculate the motion direction of the input device as the rightward direction based on the coordinates of the position P1 and the position P2. Further, as illustrated in FIG. 4B, the controller 130 may control the display 120 to display an arched feedback UI 420 on the right face of the first display item 410-1 based on the determined result. That is, a right side or face of the display item 410-1 may appear to bulge outward to display the feedback UI 420. Further, as illustrated in FIG. 4C, when the position indicated by the input device is moved to the position P3 sufficiently distant from the first display item 410-1 beyond a preset value, the controller 130 may remove the feedback UI and control the display 120 to move the highlight to the second display item 410-2 positioned to the right of the first display item 410-1.

The foregoing exemplary embodiment describes that the motion direction of the input device is to the right, which is only an example. The motion direction of the input device may be other directions such as left, up, down, and intermediate directions thereof (e.g., upper-right, lower-right, upper-left, lower-left, etc.).

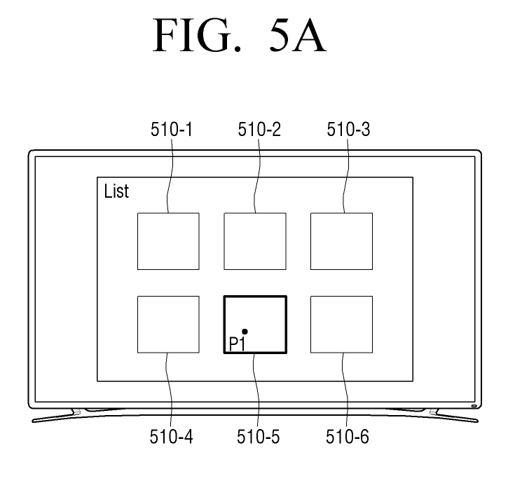

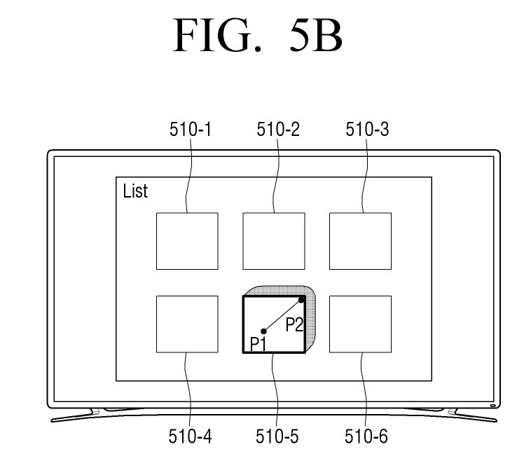

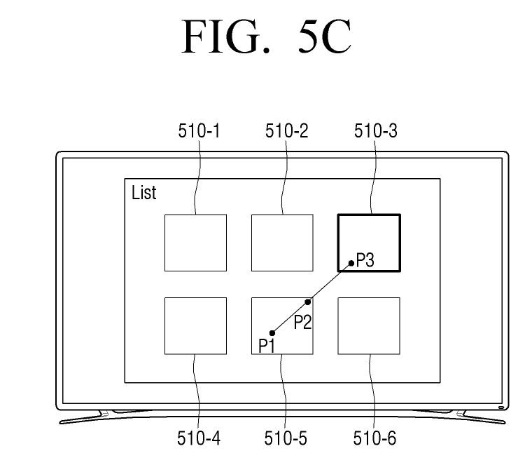

FIGS. 5A to 5C are diagrams illustrating a method of providing a feedback user interface based on diagonal motion of an input device according to an exemplary embodiment.

When the determined motion direction of the input device is a diagonal direction, the controller 130 may control the display 120 to display the feedback UI on two faces corresponding to the motion direction of the input device. For example, as illustrated in FIG. 5A, when the input device indicates the position P1 while first display item to sixth display item 510-1 to 510-6 are displayed, the controller 130 may control the display 120 to highlight the fifth display item 510-5. Further, when the input device is moved to the position P2, the controller 130 may use the coordinates P1 and P2 to determine the motion direction of the input device as to the upper-right direction. As illustrated in FIG. 5B, the controller 130 may control the display 120 to display an arched feedback UI 520 on the right face and the upper face of the fifth display item 510-5 depending on the determined result. Further, when the position indicated by the input device is moved to the position P3 sufficiently distant from the fifth display item 510-5 beyond a preset value, the controller 130 may remove the feedback UI and control the display 120 to highlight to the third display item 510-3 positioned at the upper-right direction of the fifth display item 510-5.

The foregoing exemplary embodiment describes that the motion direction of the input device is to the upper-right, which is only an example. Therefore, the motion direction of the input device may be other diagonal directions such as the upper-left, the lower-left, and lower-right.

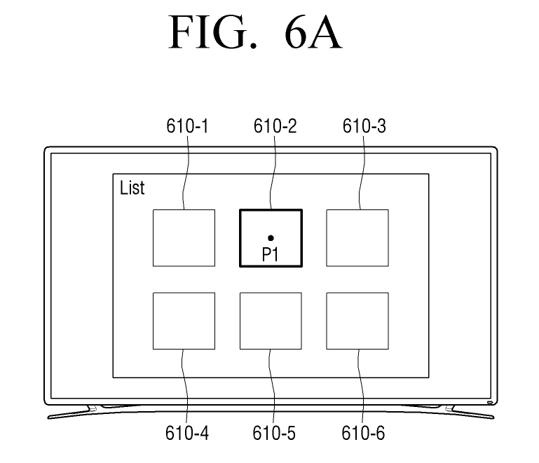

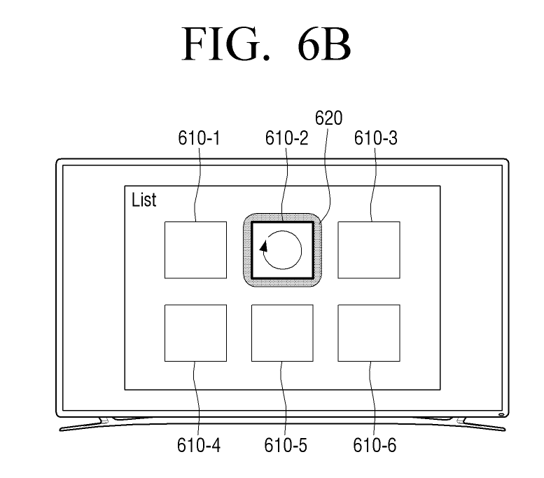

FIGS. 6A and 6B are diagrams illustrating a method for providing a feedback user interface based on rotational motion of an input device according to an exemplary embodiment.

When the input device is rotated while the position indicated by the input device is maintained within the display item, the controller 130 may control the display 120 to display the feedback UI on all faces of the first display item. For example, as illustrated in FIG. 6A, when the input device indicates the position P1 while first display item to sixth display item 610-1 to 610-6 are displayed, the controller 130 may control the display 120 to display the highlight on the second display item 610-2. Further, when the point indicated by the input device is rotated while being maintained in the second display item 610-2, as illustrated in FIG. 6C, the controller 130 may control the display 120 to display the feedback UI around all faces of the second display item 610-2. In this case, the controller 130 may provide the visual effect that the feedback UI displayed around the edges of the display item 610-2 seem to be waving or oscillating depending on the rotation direction of the input device.

Meanwhile, the controller 130 may control the display 120 to increase a size of the feedback UI as a motion value of the input device is increased. In detail, the controller 130 may use the calculated size of the direction vector to determine the motion value of the input device and control the display 120 to increase the size of the feedback UI as the motion value increases. By doing so, the user may determine the motion amount of the input device based on the increase and decrease in the size of the feedback UI.

The controller 130 may control the display 120 to increase the size of the feedback UI as the position indicated by the input device is moved from the central region of the display item to the edge region thereof. That is, when the position indicated by the input device is positioned at a point away from the center of the display item by a preset distance, the controller 130 may control the display 120 to display the feedback UI and increase the size of the feedback UI as the point indicated by the input device gradually approaches an edge of the display item.

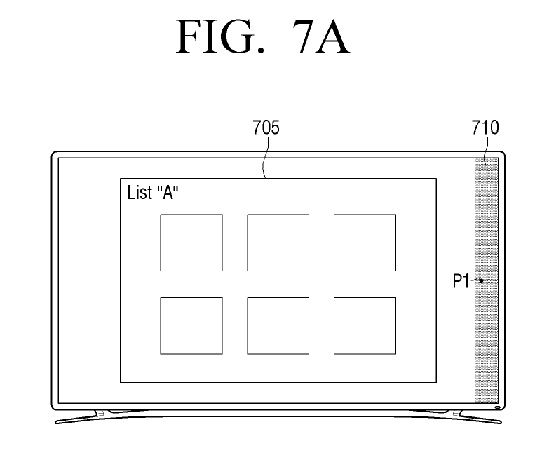

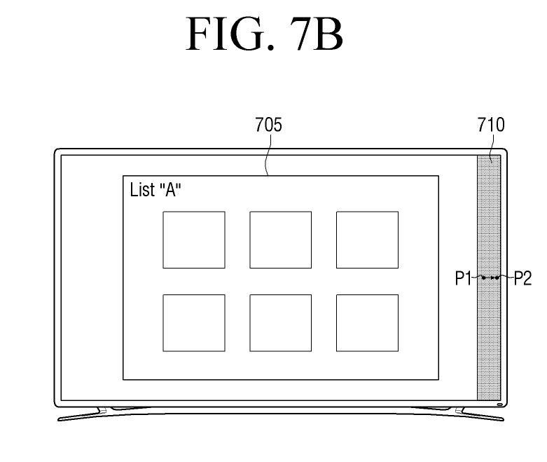

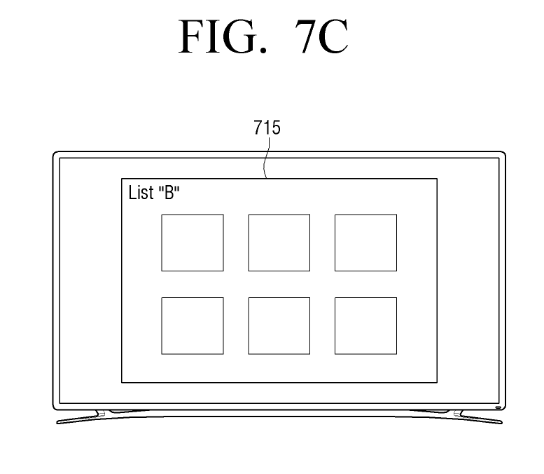

FIGS. 7A to 7C are diagrams for describing a method for providing a page changing UI according to an exemplary embodiment.

When a point indicated by an input device is positioned within a preset distance of an edge of a display screen, the controller 130 may control the display 120 to display a page changing UI on the edge within the preset distance. For example, when the position P1 indicated by the input device is within the preset distance on the right edge of the display screen while a list “A” 705 is displayed, as illustrated in FIG. 7A, the controller 130 may control the display 120 to display a bar-shaped page changing UI 710.

Further, when the position indicated by the input device contacts one of the edges of the display screen, the controller 130 may change a page in a direction corresponding to a direction of the face indicated by the input device. In detail, as illustrated in FIG. 7B, when the position indicated by the input device is moved from the P1 to the P2 to contact the right edge of the display screen, as illustrated in FIG. 7C, the controller 130 may control the display 120 to display a list “B” 715 that is a next list.

As described above, by providing the feedback UI and the feedback change UI in the state in which the pointer is not displayed, the user may intuitively determine the motion of the input device to more accurately perform the manipulation.

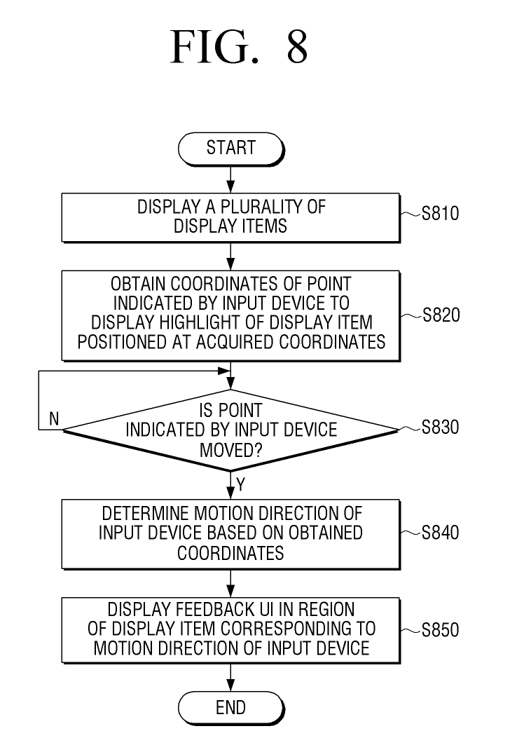

Hereinafter, a method for controlling a display device according to an exemplary embodiment will be described with reference to FIG. 8.

FIG. 8 is a flow chart illustrating a method of controlling a display device according to an exemplary embodiment.

First, the display device 100 displays the plurality of display items (S810). In this case, the plurality of display items may have a quadrangular shape, which is only an example, but the plurality of display items may have other shapes.

Further, the display device 100 obtains the coordinates of the position indicated by the input device to highlight the display item positioned at the obtained coordinates (S820). In this case, the display device 100 may directly obtain the coordinates from the input device, which is only an example. Therefore, the display device 100 may obtain the motion information from the input device to calculate the coordinates.

Further, the display device 100 determines whether the point indicated by the input device is moved (S830).

When the point indicated by the input device is moved (S830-Y), the display device 100 uses the obtained coordinates to determine the motion direction of the input device (S840). In detail, the display device 100 may use the existing obtained coordinates and the coordinates of the moved point to calculate the direction vector and use the calculated direction vector to determine the motion direction of the input device.

Further, the display device 100 displays the feedback UI in a region of the display item corresponding to the motion direction of the input device (S850). In detail, as described with reference to FIGS. 4A to 6C, the display device 100 may display the feedback UI depending on the motion direction of the input device.

By the method for controlling a display device 100 as described above, the user may intuitively determine the motion of the input device to more accurately manipulate the display device 100.

Meanwhile, the method for controlling a display device according to various exemplary embodiments may be implemented by a program and be provided to the display device or the input device. Particularly, a program including the method for controlling a display device may be stored in a non-transitory computer readable medium and executed under control of the controller.

The non-transitory computer readable medium is a medium that semi-permanently stores data therein and is readable by a device. In detail, various applications or programs described above may be stored and provided in the non-transitory computer readable medium such as a compact disk (CD), a digital versatile disk (DVD), a hard disk, a Blu-ray disk, a universal serial bus (USB), a memory card, a read only memory (ROM), or the like.

Although the exemplary embodiments have been illustrated and described hereinabove, the present disclosure is not limited to the above-mentioned specific exemplary embodiments, but may be variously modified by those skilled in the art without departing from the scope and spirit of the present disclosure as disclosed in the accompanying claims. These modifications should also be understood to fall within the scope of the present disclosure.

What is claimed is:

1. A method of controlling a display device, the method comprising:
displaying a plurality of display items on a display screen of the display device;
obtaining coordinates of a position on the display screen of the display device indicated by an input device;
highlighting a first display item among the plurality of display items that is displayed at the coordinates;
determining a motion direction of the input device based on motion information received from the input device; and
displaying a feedback user interface (UI) in a region of the first display item corresponding to the determined motion direction of the input device.

2. The method as claimed in claim 1, wherein the displaying comprises displaying the feedback UI on a face of the first display item corresponding to the motion direction of the input device, the determined motion direction of the input device corresponding to one of up, down, left, and right directions.

3. The method as claimed in claim 1, wherein the displaying comprises displaying the feedback UI on two faces of the first display item corresponding to the motion direction of the input device, the determined motion direction of the input device corresponding to a diagonal direction.

4. The method as claimed in claim 1, wherein the displaying comprises displaying the feedback UI around all faces of the first display item, the determined motion direction of the input device corresponding to a rotational direction within coordinates of the first display item.

5. The method as claimed in claim 1, wherein a size of the feedback UI increases proportionally to a size of a motion value of the input device.

6. The method as claimed in claim 1, further comprising:
determining that the position indicated by the input device is moved beyond a preset value from coordinates of the first display item;
removing the feedback UI and the highlighting from the first display item; and
highlighting a second display item among the plurality of display items positioned adjacent to the first display item in a direction of the motion direction of the input device.

7. The method as claimed in claim 1, wherein the determining comprises:
calculating a direction vector based on the obtained coordinates and the subsequent coordinates indicated by the input device; and
determining the motion direction of the input device is based on the direction vector.

8. The method as claimed in claim 1, wherein the input device is a remote controller of the display device, the remote controller comprising a motion sensor configured to sense motion of the remote controller.

9. A display device comprising:
a display configured to display a plurality of display items;
a communication interface configured to receive from an input device signaling indicating coordinates of a position on the display of the display device indicated by the input device; and
a controller configured to obtain the coordinates based on the information in the signaling, control the display to highlight a first display item among the plurality of display items that is displayed at the coordinates, determine a motion direction of the input device based on motion information in the signaling received by the communication interface from the input device, and display a feedback user interface (UI) in a region of the first display item corresponding to the determined motion direction of the input device.

10. The display device as claimed in claim 9, wherein the controller is further configured to control the display to display the feedback UI on a face of the first display item corresponding to the motion direction of the input device, the determined motion direction of the input device corresponding to one of up, down, left, and right directions.

11. The display device as claimed in claim 9, wherein the controller is further configured to control the display to display the feedback UI on two faces of the first display item corresponding to the motion direction of the input device, the determined motion direction of the input device corresponding to a diagonal direction.

12. The display device as claimed in claim 9, wherein the controller is further configured to control the display to display the feedback UI around all faces of the first display item, the determined motion direction of the input device corresponding to a rotational direction within coordinates of the first display item.

13. The display device as claimed in claim 9, wherein the controller is further configured to control the display to increase a size of the feedback UI in proportion to a size of a motion value of the input device.

14. A display device comprising:
a display configured to display a user interface, the user interface comprising a first icon having a polygon shape;
a communication interface configured to receive, from a remote controller of the display device, position information that indicates a position of the of the display pointed to by the remote controller, the position information comprising first position information that indicates a first position of the display device pointed to by the remote controller and second position information that indicates a second position of the display device pointed to by the remote controller;
a processor configured to determine a direction of motion of the remote controller from the first position to the second position based on a difference between the first position information and the second position information and control the display to display an indication of the direction of the motion extending from the first icon based on the direction of the motion of the remote controller.

15. The display device of claim 14, wherein the display is further configured to display a plurality of icons having the polygonal shape, the plurality of icons comprising the first icon.

16. The display device of claim 14, wherein the polygonal shape is a square.

17. The display device of claim 16, wherein the indication of the direction of the motion extending from the first icon comprises an arc-shaped extension of the first icon.

18. The display device of claim 17, wherein the arc-shaped extension of the first icon extends from an edge of the first icon that corresponds to the direction of the motion.

19. The display device of claim 17, wherein the direction of the motion is diagonal with respect to edges of the first icon, and
wherein the arc-shaped extension of the first icon extends from a plurality of edges of the first icon that corresponds to the diagonal direction of the motion.

20. The display device of claim 17, wherein the direction of the motion is rotational within the first icon, and
wherein the arc-shaped extension of the first icon extends around all edges of the first icon.
